(19) United States
(12) Patent Application Publication
(10) Pub. No.: US 2019/0079706 A1
(43) Pub. Date: Mar. 14, 2019

(54) IMAGE FORMING APPARATUS AND PROCESSING METHOD

(71) Applicants: KABUSHIKI KAISHA TOSHIBA, Tokyo (JP); TOSHIBA TEC KABUSHIKI KAISHA, Tokyo (JP)

(72) Inventor: Akira Saito, Mishima Shizuoka (JP)

(21) Appl. No.: 15/702,969

(22) Filed: Sep. 13, 2017

(51) Int. Cl. G06F 3/12

(52) U.S. Cl. CPC G06F 3/126; G06F 3/1285; G06F 3/1226; G06F 3/122

(57) ABSTRACT

In accordance with an embodiment, an image forming apparatus comprises a determination section, a job transfer controller, a job registration controller, and a job list delivery controller. The determination section determines registration destination of a job if a job registration request is received. The job transfer controller transfers data of the job to the registration destination determined by the determination section. The job registration controller registers data of a job transferred from another apparatus. The job list delivery controller delivers information relating to a job list for registration by the job registration controller.

### FIELD

Embodiments described herein relate generally to an image forming apparatus and a processing method.

### BACKGROUND

Conventionally, there is a case in which a system sharing data by an image forming apparatus in a serverless manner is applied.

However, in such a system, concentration of data in a specific image forming apparatus strains storage limits in some cases. On the other hand, although it is possible to execute a setting for distributing the data in the system in each device, such a setting becomes complicated to manage/implement, which is not preferable for the system administrator.

In such a system, due to the concentration of the data in a specific image forming apparatus, there is a case in which a function cannot be used at the time a failure occurs. On the other hand, although it is possible to execute setting for improving redundancy of the data in the system in each device, the setting is complicated, which is not preferable for the system administrator.

### BRIEF DESCRIPTION OF THE DRAWINGS

FIG. 1 is an external view exemplifying the overall constitution of an image forming apparatus according to an embodiment;

FIG. 2 is a diagram exemplifying the functional components of the image forming apparatus according to the embodiment;

FIG. 3 is a diagram exemplifying the functional components of a controller according to the embodiment;

FIG. 4 is a diagram exemplifying the constitution of a multistation system according to the embodiment;

FIG. 5 is a diagram illustrating an example of an operation at the time of job registration according to the embodiment;

FIG. 6 is a diagram illustrating an example of a job list according to the embodiment;

FIG. 7 is a diagram illustrating an example of the continuation of the operation at the time of the job registration according to the embodiment;

FIG. 8 is a diagram illustrating an example of a job list according to the embodiment;

FIG. 9 is a flowchart illustrating an example of the flow of a processing executed by the image forming apparatus receiving a job registration request according to the embodiment;

FIG. 10 is a flowchart illustrating an example of the flow of a processing executed by the image forming apparatus receiving a job transfer according to the embodiment;

FIG. 11 is a flowchart illustrating an example of the flow of a processing executed by the image forming apparatus receiving information on a job list according to the embodiment;

FIG. 12 is a diagram illustrating an example of an operation at the time of job printing according to the embodiment;

FIG. 13 is a diagram illustrating an example of the continuation of the operation at the time of the job printing according to the embodiment;

FIG. 14 is a diagram illustrating an example of the job list according to the embodiment;

FIG. 15 is a flowchart illustrating an example of the flow of a processing executed by the image forming apparatus issuing a job print request according to the embodiment;

FIG. 16 is a flowchart illustrating an example of the flow of a processing executed by the image forming apparatus receiving the job print request according to the embodiment;

FIG. 17 is a diagram illustrating an example of an operation at the time of the job printing according to the embodiment;

FIG. 18 is a diagram illustrating an example of the job list according to the embodiment.

FIG. 19 is a flowchart illustrating an example of the flow of a processing executed by the image forming apparatus issuing the job print request according to the embodiment.

### DETAILED DESCRIPTION

In accordance with an embodiment, an image forming apparatus comprises a determination section, a job transfer controller, a job registration controller, and a job list delivery controller. The determination section determines registration destination of a job if a job registration request is received. The job transfer controller transfers data of the job to the registration destination determined by the determination section. The job registration controller registers data of a job transferred from another apparatus. The job list delivery controller delivers information relating to a job list for registration by the job registration controller.

In accordance with an embodiment, an image forming apparatus comprises a job execution controller, a determination section, a job registration controller and a job list delivery controller. The job execution controller requests data of a job from another apparatus. The determination section determines whether to register the job in a case of receiving the data of the job requested by the job execution controller from another apparatus. The job registration controller registers the data of the job in a case in which the determination section determines that the job is registered. The job list delivery controller delivers information relating to a job list for registration by the job registration controller.

### First Embodiment

Hereinafter, an image forming apparatus of an embodiment is described with reference to the accompanying drawings. In each diagram, the same component is donated with the same reference numerals. In the following description, as an example of the image forming apparatus, an image forming apparatus 100 is described.

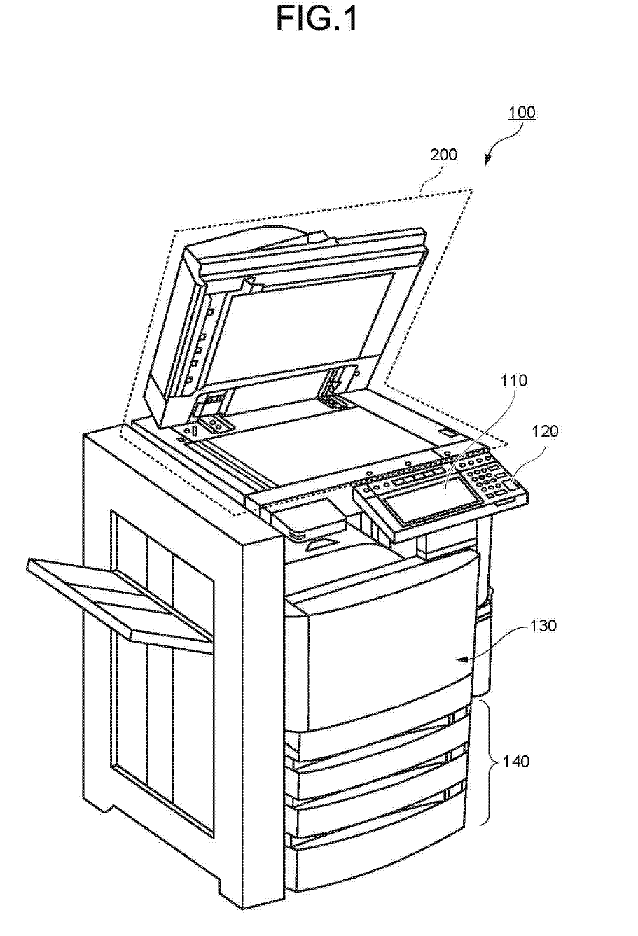

With reference to FIG. 1, the details of the image forming apparatus 100 are described below.

FIG. 1 is an external view exemplifying the whole constitution of the image forming apparatus 100 according to the embodiment. The image forming apparatus 100 is, for example, a multi-functional peripheral. The image forming apparatus 100 is provided with a display 110, a control panel 120, a printer section 130, a sheet housing section 140 and an image reading section 200. Furthermore, the printer section 130 of the image forming apparatus 100 may be a device of an electrophotographic system for fixing a toner image, or an inkjet type device.

The image forming apparatus 100 forms an image on a sheet using a developer such as a toner. The sheet is, for example, a paper. The sheet is a label paper or the like, and may be an optional object as long as the image forming apparatus 100 can form an image on a surface thereof.

The display 110 is an image display device such as a liquid crystal display, an organic EL (Electro Luminescence) display and the like. The display 110 displays various information relating to the image forming apparatus 100.

The control panel 120 includes a plurality of buttons. The control panel 120 receives an operation by a user. The control panel 120 outputs a signal in response to an operation executed by the user to a controller of the image forming apparatus 100. Furthermore, the display 110 and the control panel 120 may be constituted as an integrated touch panel.

The printer section 130 forms an image on the sheet based on image information generated by the image reading section 200 or image information received through a communication path. The printer section 130 forms an image through the following processing, for example. An image forming section of the printer section 130 forms an electrostatic latent image on a photoconductive drum based on the image information. The image forming section of the printer section 130 forms a visible image by attaching the developer to the electrostatic latent image. Toner is exemplified as a concrete example of the developer. A transfer section of the printer section 130 transfers the visible image onto the sheet. A fixing section of the printer section 130 fixes the visible image on the sheet by heating and pressurizing the sheet. The sheet on which the image is formed may be a sheet housed in the sheet housing section 140, or a sheet that is manually fed.

The sheet housing section 140 houses the sheet used in the image formation by the printer section 130.

The image reading section 200 reads the image information which is a reading object as intensity of light. The image reading section 200 records the read image information. The recorded image information may be transmitted to another information processing apparatus (an available information processing apparatus) via the network. The recorded image information may be used to form an image on the sheet by the printer section 130.

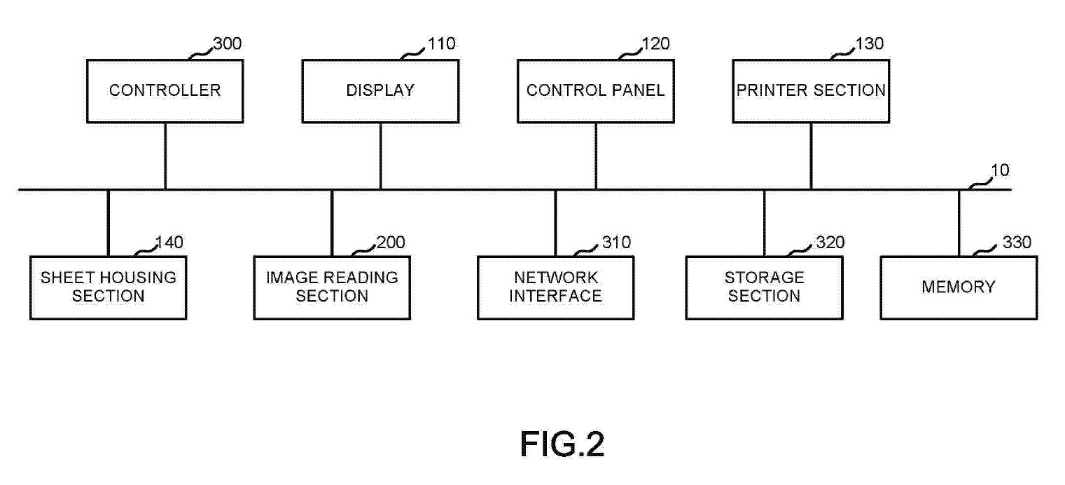

With reference to FIG. 2, the functional components of the image forming apparatus 100 are described below.

FIG. 2 is a diagram exemplifying the functional components of the image forming apparatus 100 according to the embodiment.

The image forming apparatus 100 comprises a controller 300, the display 110, and the control panel 120. The image forming apparatus 100 includes the printer section 130, the sheet housing section 140, and the image reading section 200. The image forming apparatus 100 includes a network interface 310, a storage section 320, and a memory 330. These functional sections of the image forming apparatus 100 are communicably connected via a system bus line 10.

Since the display 110, the control panel 120 and the printer section 130 are the same as those described above, the description thereof is omitted. The sheet storage section 140 and the image reading section 200 are the same as those described above, the description thereof is omitted. The controller 300, the network interface 310, the storage section 320, and the memory 330 are described below.

The controller 300 includes a CPU (Central Processing Unit) of the image forming apparatus 100. The controller 300 controls the operation of each functional section of the image forming apparatus 100. The controller 300 executes a program to execute various processing. The controller 300 acquires an instruction input by the user from the control panel 120. The controller 300 receives an operation from the user through the control panel 120. The controller 300 executes a control processing based on the acquired instruction.

The network interface 310 transmits and receives data with other devices. The network interface 310 operates as an input interface to receive the data transmitted from other devices. The network interface 310 operates as an output interface to transmit the data to other devices.

The storage section 320 is an auxiliary storage device such as a hard disk, an SSD (Solid State Drive), etc. The storage section 320 stores various data.

The memory 330 is, for example, a RAM (Random Access Memory). The memory 330 temporarily stores data used by each functional section of the image forming apparatus 100. The memory 330 may store the data generated by the image reading section 200 and a program for operating the functional section.

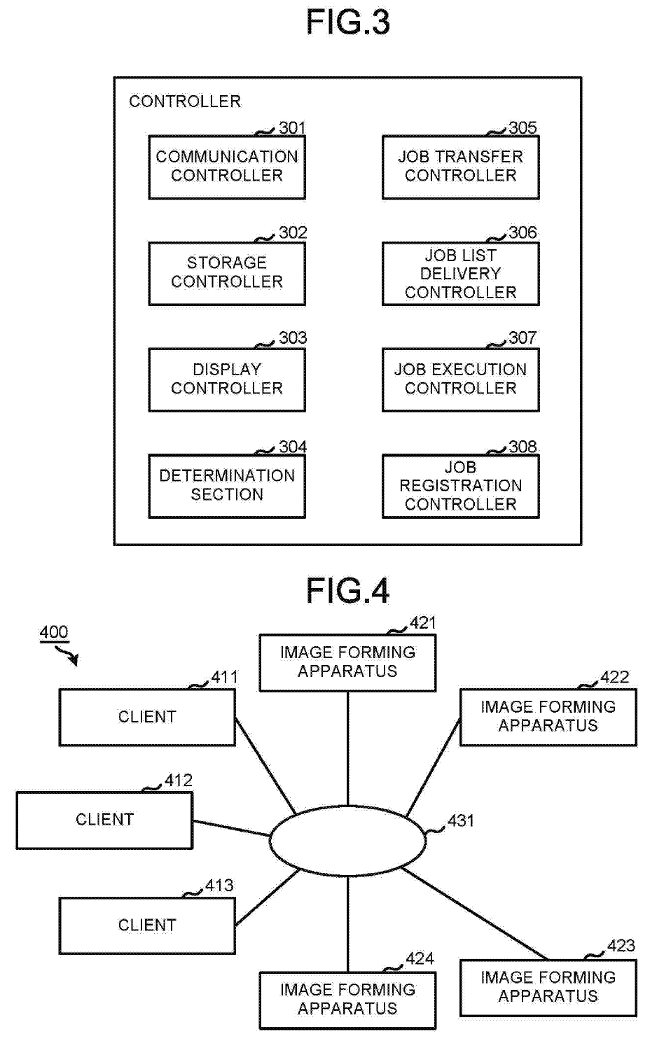

With reference to FIG. 3, the functional components of the controller 300 are described below.

FIG. 3 is a diagram illustrating an example of the functional components of the controller 300 according to the embodiment.

The controller 300 includes a communication controller 301, a storage controller 302, and a display controller 303. The controller 300 includes a determination section 304, a job transfer controller 305, and a job list delivery controller 306. The controller 300 further includes a job execution controller 307 and a job registration controller 308. Apart or all of these functional sections maybe hardware functional sections such as an LSI (Large Scale Integration) or an ASIC (Application Specific Integrated Circuit).

The communication controller 301 communicates with other devices via the network interface 310.

The storage controller 302 stores information and deletes the stored information in the storage section 320 and the memory 330.

The display controller 303 generates various images in response to an operation received from the user. The display controller 303 displays the generated image on the display 110.

The determination section 304 executes various kinds of determination. For example, the determination section 304 determines the image forming apparatus that is required to store data of a job to decide it. The determination section 304 determines whether to transfer the data of the job. The determination section 304 determines whether or not the data of the job is received. The determination section 304 determines whether or not information on a job list is received. The determination section 304 determines whether or not rewriting of the job list is necessary. If the job list is rewritten, contents of the job list are changed.

The job transfer controller 305 performs control to transfer the data of the job.

The job list delivery controller 306 performs control to deliver the information of the job list.

The job execution controller 307 controls execution of a job such as printing or copying. In the present embodiment, a printing job is described as an example. As the job, any arbitrary job may be used.

The job registration controller 308 controls registration of the job.

Herein, a predetermined functional section may utilize a function of another functional section at the time of executing the control, respectively. The predetermined functional section is, for example, the determination section 304, the job transfer controller 305, the job list delivery controller 306, the job execution controller 307, or the job registration controller 308. As the functions of the other functional sections mentioned here, there is a communication control by the communication controller 301, a storage control by the storage controller 302, and a display control by the display controller 303.

With reference to FIG. 4, an example of the constitution of a multistation system 400 is described.

FIG. 4 is a diagram exemplifying the constitution of the multistation system 400 according to the embodiment.

The multistation system 400 includes three clients 411˜413 and four image forming apparatuses 421˜424. The multistation system 400 includes a network 431 that connects them in a communicable manner. The number of the clients 411˜413 is an example, and may be an arbitrary number of 1 or more. The number of the image forming apparatuses 421˜424 is an example, and may be an arbitrary number of 2 or more. For example, the network 431 may use a wired line or a wireless line.

Herein, each of the image forming apparatuses 421˜424 has the same function as the image forming apparatus 100 described with reference to FIG. 1˜FIG. 3. Therefore, in the following, the functions of each of the image forming apparatuses 421˜424 are described using the functional sections described with reference to FIG. 1˜FIG. 3.

In addition, each of the clients 411˜413 is, for example, a personal computer. Each of the clients 411˜413 may be any arbitrary computer.

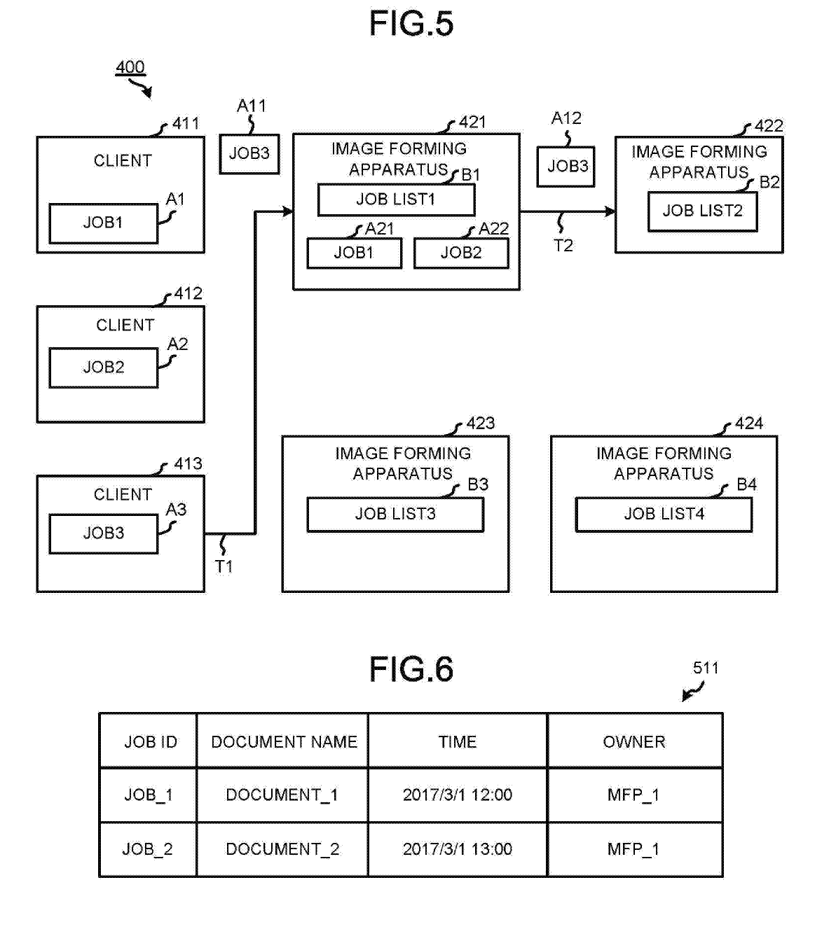

With reference to FIG. 5˜FIG. 11, distribution of processing data at the time of the job registration is described below.

With reference to FIG. 5, an example of the operation at the time of the job registration is described.

FIG. 5 is a diagram illustrating an example of the operation at the time of the job registration according to the embodiment.

FIG. 5 schematically shows an example of the state of the multistation system 400. In FIG. 5, for ease of view of the figure, the illustration of the network 431 is omitted. In FIG. 5, a communication flow is indicated by an arrow in order to make the communication flow easy to understand.

In the present embodiment, the four image formation apparatuses 421˜424 cooperate with each other to execute the processing.

In the clients 411˜413, drivers for using the functions of the image forming apparatuses 421˜424 are set, respectively. The driver is, for example, a printer driver. In the driver, one image forming apparatus to which the data of the job is required to be transmitted is set. The setting is executed using, for example, identification information of each of the image forming apparatuses 421˜424.

In the present example, the client 411 stores data of a job A1. The client 412 stores data of a job A2. The client 413 stores data of a job A3. In this way, the data of the jobs A1˜A3 is held in the clients 411˜413, respectively. In the present embodiment, the data of the jobs A1˜A3 is print data.

The clients 411˜413 store job lists B1˜B4 in the storage section 320, respectively.

The client 411 already transmits the data of the job A1 to the image forming apparatus 421. The image forming apparatus 421 already receives the data of the job A1 and registers the job A1. Specifically, the image forming apparatus 421 registers the job A1 by storing the data of a job A21 corresponding to the data of the job A1 in the storage section 320. The image forming apparatus 421 becomes an owner of the job A1. The data of the job A21 corresponding to the data of job A1 is, for example, data created by the job execution controller 307 to execute the job A1.

The image forming apparatus 421 rewrites the job list B1 of the image forming apparatus 421 to reflect the information on the registered job A1 in the job list B1. The image forming apparatus 421 shares information on the job list with other image forming apparatuses 422˜424 cooperating therewith. Specifically, the image forming apparatus 421 delivers the information on the job list by transmitting it to the other image forming apparatuses 422˜424. The information on the job list includes at least a change part. In the present example, the information on the job list includes at least the information on the job A1. The other image forming apparatuses 422˜424 receive the information on the job list. Then, the other image forming apparatuses 422˜424 rewrite the job lists B2˜B4 thereof to reflect the information on the job A1 in the job lists B2˜B4.

Similarly, the client 412 already transmits the data of the job A2 to the image forming apparatus 421. The image forming apparatus 421 already receives the data of the job A2 to register the job A2. The same processing as the job A1 described above is also executed for the job A2. As a result, the jobs A1 and A2 are registered in the image forming apparatus 421.

With reference to FIG. 6, a job list 511 is described.

FIG. 6 is a diagram illustrating an example of the job list 511 according to the embodiment.

The job list 511 is an example of the job lists B1˜B4.

The job list 511 stores a job ID, a document name, a time, and an owner in an associated manner. The job ID is used for identifying a job. The document name is a name of a document which is a processing object corresponding to the job. In the present embodiment, the processing refers to a printing processing. The time is a time of registration or change in the job list 511. The owner is used for identifying the image forming apparatuses 421˜424 storing the data of the job. As the information for identifying the job, arbitrary information may be used. As the information for identifying the image forming apparatus, arbitrary information may be used.

In the job list 511, a “Job_1” is stored as the job ID of the job A1. A “Document_1” is stored as the document name of the job A1. “2017/3/1 12: 00” is stored as the time for the job A1. An “MFP_1” is stored as the owner of the job A1.

Similarly, a “Job_2” is stored as the job ID of the job A2. A “Document_2” is stored as the document name of the job A2. “2017/3/1 13: 00” is stored as the time for the job A2. An “MFP_1” is stored as the owner of the job A2. The “MFP_1” is used to specify the image forming apparatus 421.

Herein, an example of subsequent processing is described by setting a state of the multistation system 400 to the above state.

Generally, the drivers of the clients 411˜413 determine the image forming apparatuses 421˜424 to which processing data is required to be transferred. Therefore, if a transfer destination of the processing data is not distributed in the clients 411˜413 in the system, there is a case in which the processing data concentrates. The processing data concentrates in the specific image forming apparatuses 421˜424.

First, the state shown in FIG. 5 and FIG. 6 is assumed. A case in which a new job is registered in this state is described.

In this state, the client 413 transmits the data of job A3 to the image forming apparatus 421 as a job registration request processing T1. FIG. 5 shows the data of job A3 communicated via the network 431 as the data of the job A11.

The image forming apparatus 421 receives the data of the job A3 transmitted from the client 413. In this case, the image forming apparatus 421 specifies the image forming apparatus having a smaller number of registered jobs than that in the image forming apparatus 421 among the plurality of the image forming apparatuses 421˜424 cooperating with each other. As an example, the image forming apparatus 421 may specify the image forming apparatus having the least number of the registered jobs among the plurality of the image forming apparatuses 421˜424 cooperating with each other. In the present example, the number of registered jobs represents the number of jobs being held.

The image forming apparatus 421 executes a processing for registering the received job A3 to the specified image forming apparatus. Specifically, if the image forming apparatus 421 specifies itself, the image forming apparatus 421 registers the job A3 by storing the data of the job A3 in the storage section 320 of the image forming apparatus 421. The image forming apparatus 421 registers the job A3 in the other specified image forming apparatuses 422˜424 if the other image forming apparatuses 422˜424 are specified.

In the present example, the image forming apparatus 421 specifies the other image forming apparatus 422 as the registration destination of the job A3. Then, the image forming apparatus 421 transfers the data by transmitting the data of the job A3 to the other image forming apparatus 422 as a transfer processing T2.

Herein, the image forming apparatus 421 shares the number of registered jobs in each of the image forming apparatuses 421˜424 with the other image forming apparatuses 422˜424. As an example, each of the image forming apparatuses 421˜424 transmits the information on the number of registered jobs in the own apparatus to the other image formation apparatuses 421˜424. As another example, each of the image forming apparatuses 421˜424 inquires the number of registered jobs in the other image forming apparatuses 421˜424 and receives the information. A timing of notifying the information on each number of registered jobs among the plurality of the image forming apparatuses 421˜424 may be optional. The timing may be, for example, a timing at which it becomes necessary to specify the image forming apparatus having a small number of registered jobs. As another example, the timing may be a timing of a fixed cycle.

As another example, each of the image forming apparatuses 421˜424 may acquire each number of registered jobs based on the information of the job lists B1˜B4 therein. The image forming apparatuses 421˜424 may acquire the registration number of jobs owned by itself as the number of registered jobs in each of the other image forming apparatuses 421˜424. In this case, the image forming apparatus 421˜424 can grasp the number of registered jobs therein without communicating with the other image forming apparatuses 421˜424.

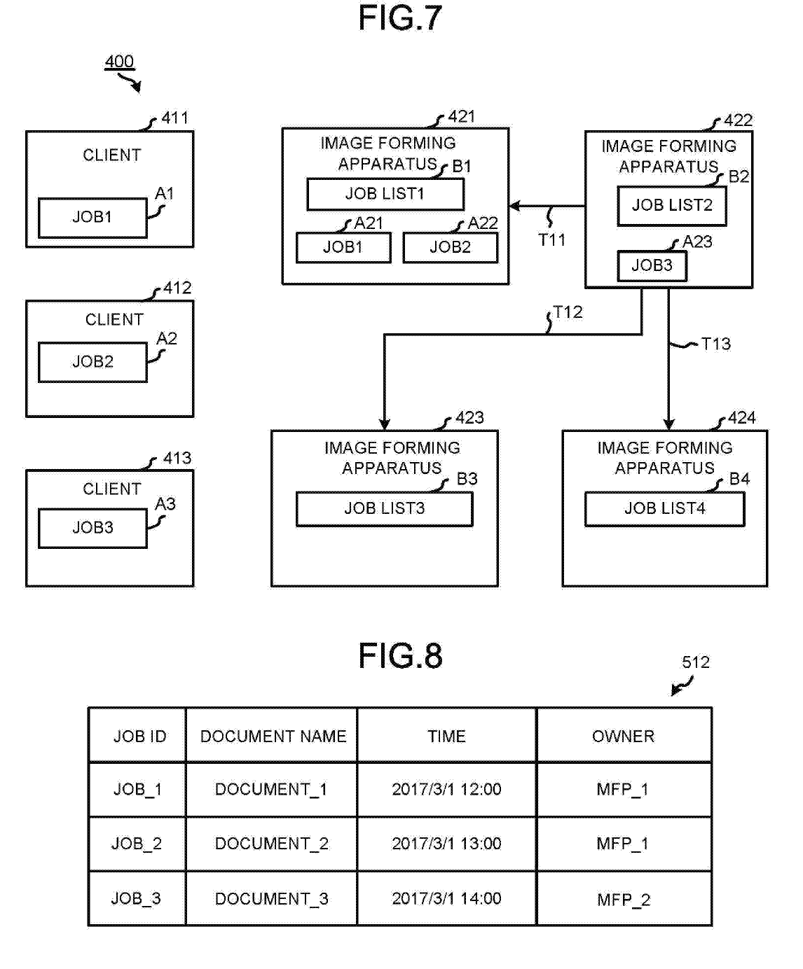

With reference to FIG. 7, an example of continuation of the operation at the time of the job registration is described.

FIG. 7 is a diagram illustrating an example of the continuation of the operation at the time of the job registration according to the embodiment.

In FIG. 7, a subsequent part of the operation is described with respect to the state shown in FIG. 5. In addition, in FIG. 7, the network 431 is omitted for ease of view of the figure. FIG. 7 shows a communication flow by an arrow in order to make the communication flow easy to understand.

The image forming apparatus 422 receives the data of the job A3 from the image forming apparatus 421. The image forming apparatus 422 registers the job A3 by storing the received data of the job A3 in the storage section 320. Specifically, the image forming apparatus 422 creates data of a job A23 corresponding to the data of the job A3 to store the data.

The image forming apparatus 422 rewrites the job list B2 of the image forming apparatus 422 to reflect the information on the registered job A3 in the job list B2. The image forming apparatus 422 shares the information on the job list with the other image forming apparatuses 421, 423 and 424 cooperating therewith. Specifically, the image forming apparatus 422 delivers the information on the job list by transmitting it to the other image forming apparatuses 421, 423 and 424. The information on the job list includes at least a change part.

In the present example, the image forming apparatus 422 transmits the information on the job list to the image forming apparatus 421 as a job list delivery processing T11. The image forming apparatus 422 transmits the information on the job list to the image forming apparatus 423 as a job list delivery processing T12. The image forming apparatus 422 transmits the information on the job list to the image forming apparatus 424 as a job list delivery processing T13.

In the present example, the information on the job list includes at least the information on the job A3. The other image forming apparatuses 421, 423 and 424 receive the information on the job list. Then, the other image forming apparatuses 421, 423 and 424 rewrites the job lists B1, B3˜B4 of the other image forming apparatuses 421, 423 and 424, to reflect information on the job A3 in the job lists B1, B3˜B4.

In the present embodiment, the contents of the job lists B1˜B4 are matched in the plurality of the image forming apparatuses 421˜424 cooperating with each other. If the contents of these job lists B1˜B4 are changed, there may be unmatched contents; however, after the change, the contents thereof are the same.

With reference to FIG. 8, a job list 512 is described.

FIG. 8 is a diagram illustrating an example of the job list 512 according to the embodiment.

The job list 512 is an example of the job lists B1˜B4.

The job list 512 has contents obtained by changing the job list 511 shown in FIG. 5. The changed part is that the information on the job A3 is added to the job list 512.

Specifically, a “Job_3” is stored as job ID of the job A3 in the job list 512. A “Document_3” is stored as the document name of the job A3. A “2017/3/1 14: 00” is stored as the time for the job A3. An “MFP_2” is stored as the owner for the job A3. The “MFP_2” is used to specify the image forming apparatus 422.

Herein, as a condition for determining the image forming apparatuses 421˜424 which are registration destinations of the data of the job, any condition may be used. If the registration destination is another apparatus, it becomes a transfer destination. In the present example, the condition is that the number of registered jobs is small. The condition may be, for example, that the number of registered jobs is the smallest. As another example, the condition is that a free capacity of the storage is large. For example, the condition may be that the free capacity of the storage is the largest. In the present embodiment, the storage is the storage section 320.

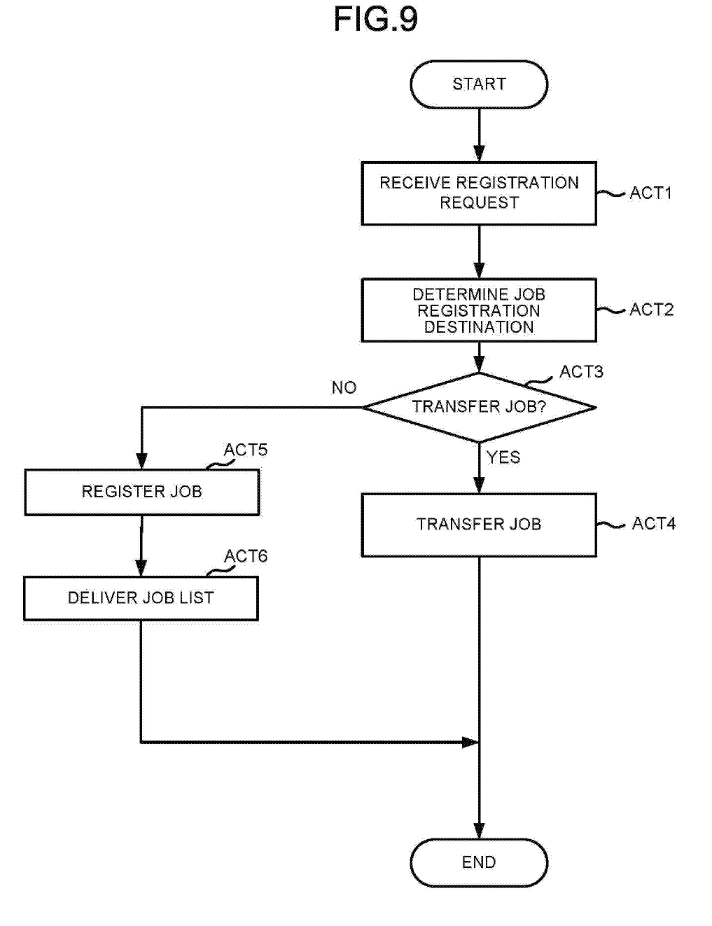

With reference to FIG. 9, the flow of a processing executed by the image forming apparatus 421 receiving the job registration request is described.

FIG. 9 is a flowchart illustrating an example of the flow of a processing executed by the image forming apparatus 421 receiving the job registration request according to the embodiment.

In the image forming apparatus 421, a job registration request is received from the client 413 for the job A3 (ACT 1). In the image forming apparatus 421, the data of the job A3 is received from the client 413.

Then, the determination section 304 determines the number of registered jobs in the plurality of the image forming apparatuses 421˜424. As a result, the determination section 304 determines one of the image forming apparatuses which is the registration destination of the job A3, and decides the determined image forming apparatus as the registration destination of the job A3 (ACT 2).

The determination section 304 determines whether to transfer the data of job A3 (ACT 3). Specifically, the determination section 304 determines that the data is transferred if the registration destination of the job A3 is the other image forming apparatus (Yes in ACT 3), and proceeds to the processing in ACT 4. On the other hand, the determination section 304 determines that the data is not transferred if the registration destination of job A3 is the image forming apparatus 421 (No in ACT 3), and proceeds to the processing in ACT 5.

In ACT 4, the job transfer controller 305 transfers the data of the job A3 to the image forming apparatus (in the present example, the image forming apparatus 422) which is the registration destination (ACT 4). Thereafter, the present flow is ended.

In ACT 5, the job registration controller 308 registers the job A3 in the image forming apparatus 421 by storing the data of the job A3 in the storage section 320 (ACT 5). In this registration, the job registration controller 308 rewrites the job list B1 in the image forming apparatus 421. Then, the job list delivery controller 306 delivers the information on the rewritten job list B1 to the other image forming apparatuses 422˜424 (ACT 6). Thereafter, the present flow is ended. The information includes at least the information on the job A3 that is newly registered.

Herein, the operation in FIG. 9 is described by using the image forming apparatus 421 as an example; however, the other image forming apparatuses 422˜424 also have the function of executing the same operations.

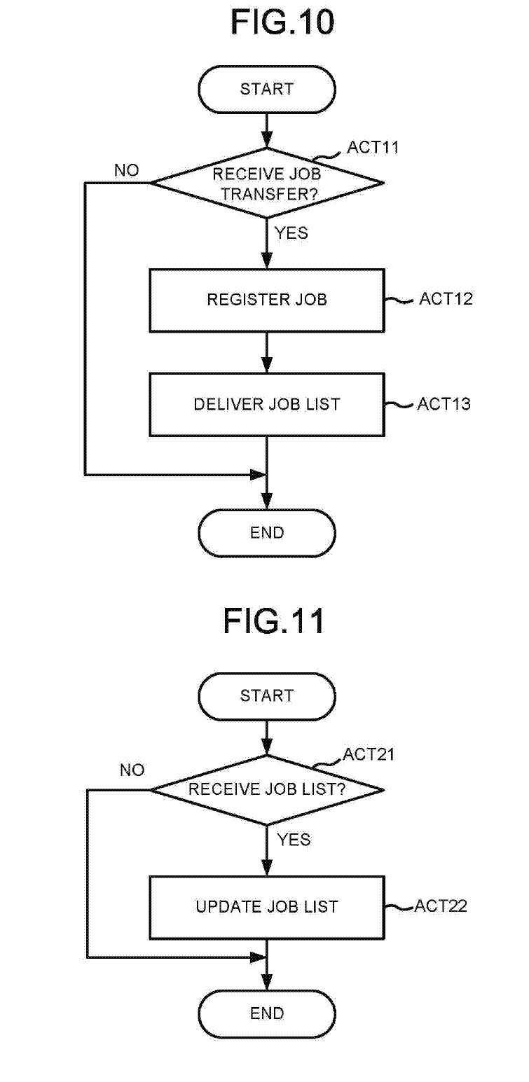

With reference to FIG. 10, the flow of a processing executed by the image forming apparatus receiving the transfer of the job is described.

FIG. 10 is a flowchart illustrating an example of the flow of the processing executed by the image forming apparatus 422 receiving the transfer of the job of the embodiment.

The determination section 304 determines whether or not the data of the job transferred from the other image forming apparatuses 421, 423 and 424 is received (ACT 11). As a result, if the determination section 304 determines that the transferred data of the job is received (Yes in ACT 11), the determination section 304 proceeds to the processing in ACT 12. On the other hand, if the determination section 304 determines that the transferred data of the job is not received (No in ACT 11), the processing in the present flow is ended.

In ACT 12, the job registration controller 308 registers the received job (in the present example, job A3) in the image forming apparatus 422 (ACT 12). Specifically, the job registration controller 308 registers the job in the image forming apparatus 422 by storing the data of the job in the storage section 320. In this registration, the job registration controller 308 rewrites the job list B2 in the image forming apparatus 422. Then, the job list delivery controller 306 delivers information on the rewritten job list B2 to the other image forming apparatuses 421, 423 and 424 (ACT 13). Thereafter, the present flow is ended. The information includes at least information on the newly registered job A3.

Herein, the operation in FIG. 10 is described by using the image forming apparatus 422 as an example; however, the other image forming apparatuses 421, 423 and 424 also have the function of executing the same operations.

With reference to FIG. 11, the flow of a processing executed by the image forming apparatuses 421, 423 and 424 receiving the information on the job list is described.

FIG. 11 is a flowchart illustrating an example of the flow of the processing executed by the image forming apparatuses 421, 423 and 424 receiving the information on the job list according to the embodiment. The processing executed by each of the image forming apparatuses 421, 423 and 424 is similar. Therefore, the operation by the image forming apparatus 421 is described as an example.

In the image forming apparatus 421, the determination section 304 determines whether or not the information on the job list is received from the other image forming apparatuses 422˜424 (ACT 21). As a result, if the determination section 304 determines that the information on the job list is received (Yes in ACT 21), the determination section 304 proceeds to the processing in ACT 22. On the other hand, if the determination section 304 determines that the information on the job list is not received (No in ACT 21), the processing of the present flow is ended.

In the ACT 22, the job registration controller 308 rewrites the job list B1 of the image forming apparatus 421 (ACT 22) based on the information on the received job list. As a result, the contents of the job list B1 are updated. Then the processing of the present flow is ended.

Herein, the operation in FIG. 11 is described by using the image forming apparatuses 421, 423 and 424 as an example; however, the other image forming apparatuses 422 also has the function of executing the same operations.

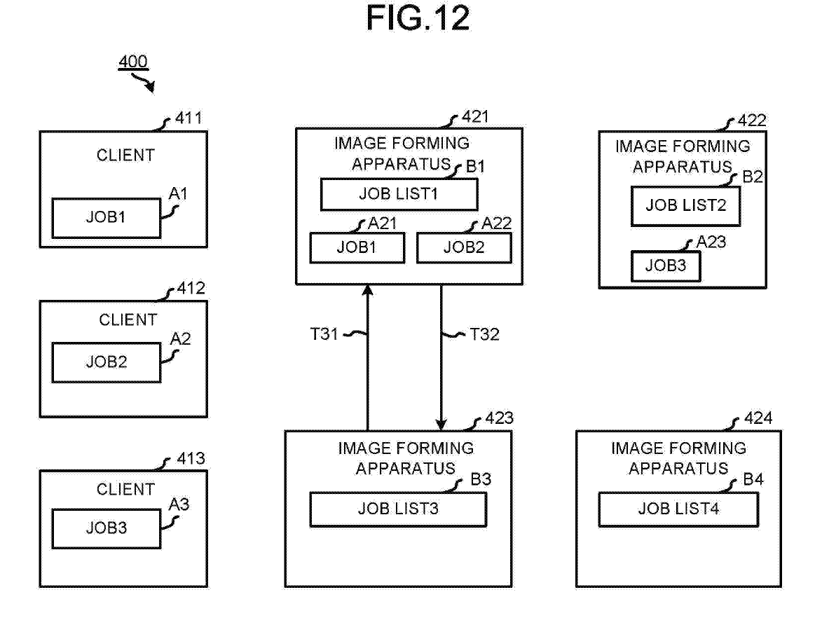

With reference to FIG. 12 to FIG. 16, the distribution of the processing data at the time of printing a job is described.

With reference to FIG. 12, an example of the operation at the time of printing the job is described.

FIG. 12 is a diagram illustrating an example of the operation at the time of printing the job according to the embodiment. In FIG. 12, for ease of view of the figure, the illustration of the network 431 is omitted. In FIG. 12, a communication flow is indicated by an arrow in order to make the communication flow easy to understand.

First, the state shown in FIG. 7 and FIG. 8 is assumed. In this state, a case in which a new job is printed is described.

In this state, the image forming apparatus 423 transmits a signal requesting the data of the job A2 to the image forming apparatus 421 as a print data request processing T31.

The image forming apparatus 421 receives a request signal of the data of the job A2 transmitted from the image forming apparatus 423. In this case, as a print data transmission processing T32, the image forming apparatus 421 transmits the data of the job A2 to the image forming apparatus 423 as the requested print data.

Next, the image forming apparatus 423 specifies the image forming apparatus having a smaller number of registered jobs between the image forming apparatus 421 and the image forming apparatus 423. As stated above, instead of the number of registered jobs, a free capacity of the storage may be used as the condition for determination.

The image forming apparatus 423 executes a processing for registering the received job A2 in the specified image forming apparatus. Specifically, if the image forming apparatus 423 is specified, the image forming apparatus 423 registers the job A2 by storing the data of the job A2 in the storage section 320 of the image forming apparatus 423. If the image forming apparatus 421 which is a transmission source of the job A2 is specified, the image forming apparatus 423 keeps a state in which the job A2 is registered in the specified image forming apparatus 421.

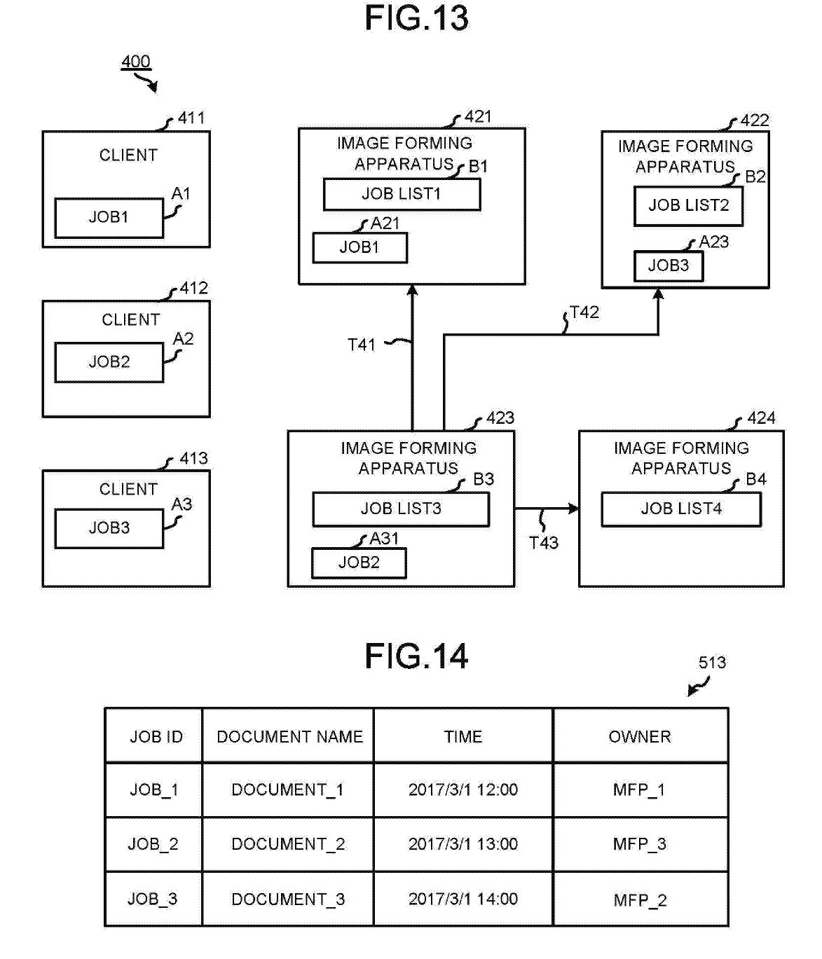

With reference to FIG. 13, an example of the continuation of the operation at the time of printing the job is described.

FIG. 13 is a diagram illustrating an example of the continuation of the operation at the time of printing the job in the embodiment. In FIG. 13, for ease of view of the figure, the illustration of the network 431 is omitted. In FIG. 13, a communication flow is indicated by an arrow in order to make the communication flow easy to understand.

In the present example, the image forming apparatus 423 specifies the image forming apparatus 423 as the registration destination of the job A2. Then, the image forming apparatus 423 registers the job A2 in the image forming apparatus 423 by storing the data of the job A2 which is the print data in the storage section 320. Specifically, the image forming apparatus 423 creates the data of the job A31 corresponding to the data of the job A2 to store it. Herein, similarly to the above, the image forming apparatus 423 shares the number of registered jobs in each of the image forming apparatuses 421 and 423 with the other image forming apparatus 421. Similarly to the above, as another example, the image forming apparatuses 421 and 423 may acquire the number of registered jobs of the other image forming apparatuses 421 and 423 based on the information of the job lists B1 and B3 in the image forming apparatuses 421 and 423.

The image forming apparatus 423 rewrites the job list B3 of the image forming apparatus 423 to reflect the information on the registered job A2 in the job list B3. The image forming apparatus 423 shares the information on the job list with the other image forming apparatuses 421,422 and 424 cooperating therewith. Specifically, the image forming apparatus 423 delivers the information on the job list by transmitting it to the other image forming apparatuses 421, 422 and 424. The information on the job list includes at least a change part.

In the present example, the image forming apparatus 423 transmits the information on the job list to the image forming apparatus 421 as a job list delivery processing T41. The image forming apparatus 423 transmits the information on the job list to the image forming apparatus 422 as a job list delivery processing T42. The image forming apparatus 423 transmits the information on the job list to the image forming apparatus 424 as a job list delivery processing T43.

In the present example, the information on the job list includes at least the information on the job A2. The other image forming apparatuses 421, 422 and 424 receive the information on the job list. Then, the other image forming apparatuses 421, 422 and 424 rewrite the job lists B1, B2 and B4 thereof. As a result, the other image forming apparatuses 421, 422 and 424 reflect the information on the job A2 in the job lists B1, B2 and B4.

Furthermore, the image forming apparatus 421 which is the transmission source of the job A2 receives information indicating that the image forming apparatus 423 registers the job A2. In the present example, the information is information on the job list transmitted from the image forming apparatus 423. As another example, the image forming apparatus 423 may transmit the information indicating that the job A2 is registered to the image forming apparatus 421 in addition to the information on the job list. In a case of receiving the notification that the image forming apparatus 423 registers the job A2, the image forming apparatus 421 deletes the data of the job A2 stored in the image forming apparatus 421. As a result, the owner of the job A2 changes from the image forming apparatus 421 to the image forming apparatus 423.

Furthermore, if the image forming apparatus 423 specifies the image forming apparatus 421 which is the transmission source as the registration destination of the job A2, the image forming apparatus 423 deletes the data of the received job A2 after processing. In the present example, in the image forming apparatus 423, the job execution controller 307 controls the processing for printing the data of the job A2.

With reference to FIG. 14, a job list 513 is described.

FIG. 14 is a diagram illustrating an example of the job list 513 according to the embodiment.

The job list 513 is an example of the job lists B1˜B4.

The job list 513 has contents obtained by changing the job list 512 shown in FIG. 8. The changed part relates to the information on the job A2.

Specifically, the “Job_2” is stored as the job ID of the job A2 in the job list 513. The “Document_2” is stored as the document name of the job A2. “2017/3/1 13: 00” is stored as time for the job A2. An “MFP_3” is stored as the owner of the job A2. The “MFP_3” is used for specifying the image forming apparatus 423. In other words, in the present example, the owner of the job A2 is changed from the image forming apparatus 421 to the other image forming apparatus 423.

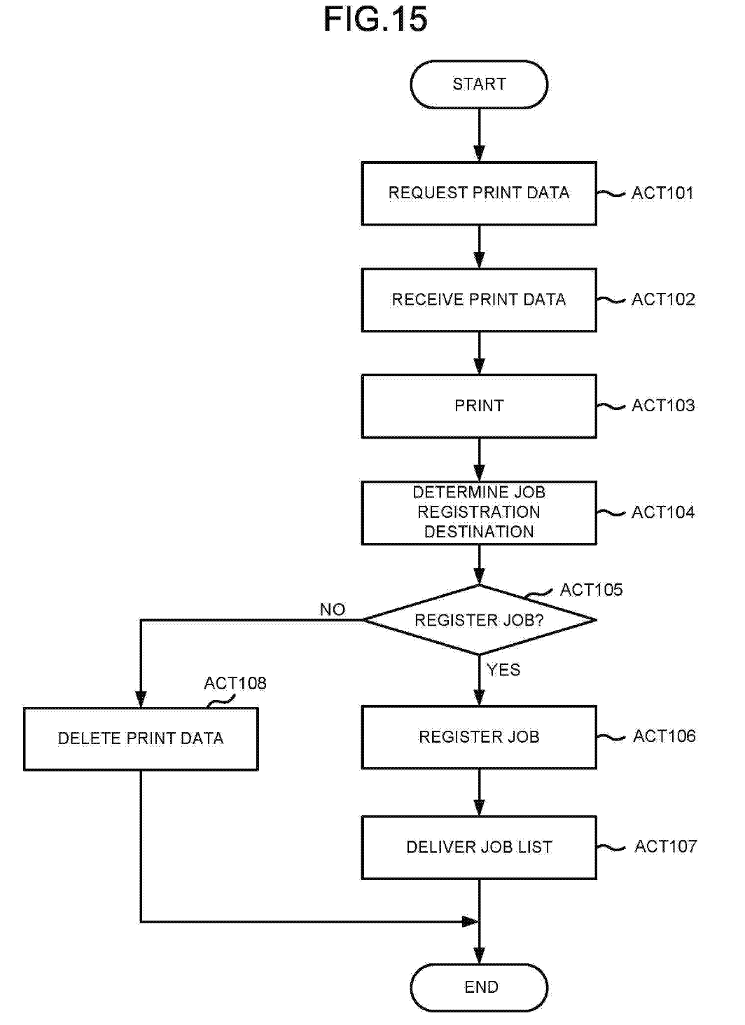

With reference to FIG. 15, an example of the flow of the processing executed by the image forming apparatus 423 issuing a job print request is described.

FIG. 15 is a flowchart illustrating an example of the flow of a processing executed by the image forming apparatus issuing the job print request according to the embodiment.

In the image forming apparatus 423, in a case of printing the print data, the job execution controller 307 requests the print data based on the contents of the job list B3 (ACT 101). In the present example, the job execution controller 307 requests the data of the job A2 as the print data from the image forming apparatus 421.

Next, the image forming apparatus 423 receives the print data transmitted from the image forming apparatus 421 (ACT 102). Then, the job execution controller 307 executes the processing of the received print data (ACT 103).

Next, the determination section 304 determines the number of registered jobs for the image forming apparatus 423 and the image forming apparatus 421. As a result, the determination section 304 determines one of the image forming apparatuses which is the registration destination of the job A2, and decides the determined image forming apparatus as the registration destination of the job A2 (ACT 104).

The determination section 304 determines whether to register the data of the job A2 in the image forming apparatus 423 (ACT 105). Specifically, if the registration destination of the job A2 is the image forming apparatus 423, the determination section 304 determines to register the data of the job A2 (Yes in ACT 105), and proceeds to the processing in ACT 106. On the other hand, the determination section 304 determines that the data of the job A2 is not registered (No in ACT 105) if the registration destination of the job A2 is the other image forming apparatus 421, and proceeds to the processing in ACT 108.

In the ACT 106, the job registration controller 308 registers the job A2 in the image forming apparatus 423 by storing the data of the job A2 in the storage section 320 (ACT 106). In this registration, the job registration controller 308 rewrites the job list B3 in the image forming apparatus 423. Then, the job list delivery controller 306 delivers the information on the rewritten job list B3 to the other image forming apparatuses 421, 422 and 424 (ACT 107). After that, the present flow is ended. The information includes at least information on the newly registered job A2.

In the ACT 108, the job registration controller 308 deletes the data of the job A2. In this case, the registration destination of the job A2 remains to be the image forming apparatus 421. Thereafter, the present flow is ended.

Herein, the operation in FIG. 15 is described by using the image forming apparatus 423 as an example; however, the other image forming apparatuses 421, 422 and 424 also have the function of executing the same operations.

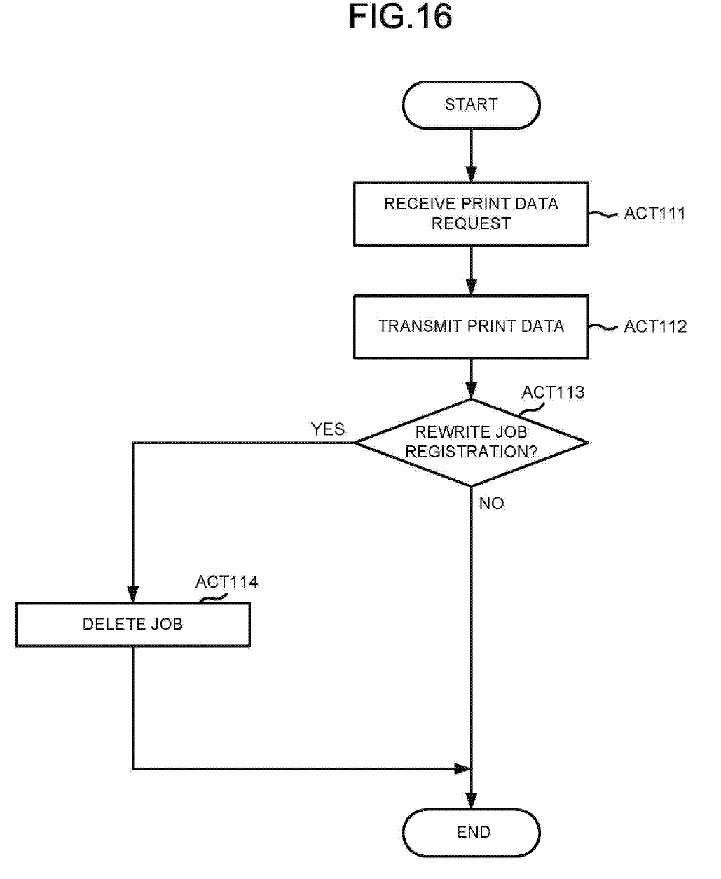

With reference to FIG. 16, a processing executed by the image forming apparatus 421 receiving the job print request is described.

FIG. 16 is a flowchart illustrating an example of the flow of a processing executed by the image forming apparatus 421 receiving the job print request according to the embodiment.

In the image forming apparatus 421, a request for the print data is received from the other image forming apparatus (in the present example, the image forming apparatus 423) (ACT 111). Then, the job execution controller 307 transfers the requested print data (in the present example, the data of the job A2) to the other image forming apparatus (ACT 112).

Next, the determination section 304 determines whether or not it is necessary to rewrite the job list B1 for the transmitted print data (ACT 113). As a result, if the determination section 304 determines that it is necessary to rewrite the job list B1 (Yes in ACT 113), the determination section 304 proceeds to processing in ACT 114. On the other hand, if the determination section 304 determines that it is not necessary to rewrite the job list B1 (No in ACT 113), the processing of the present flow is ended. In the present example, the determination section 304 determines to rewrite the job list B1 if the image forming apparatus 423 requesting the print data registers the job A2. Whether to register the data is determined depending on presence or absence of notification from the image forming apparatus 423.

In ACT 114, the job registration controller 308 deletes the data of the job A2. In this case, the registration destination of the job A2 is changed to the image forming apparatus 423. Thereafter, the present flow is ended.

Herein, the operation in FIG. 16 is described by using the image forming apparatus 421 as an example; however, the other image forming apparatuses 422˜424 also have the function of executing the same operations.

The flow of the processing executed by the image forming apparatuses 421, 422 and 424 receiving the information on the job list is similar to that in a case shown in FIG. 11.

In this way, in the server-less multistation system 400, the data of the job is automatically transferred in the system. The data becomes the print data. Thus, a storage location of the data of the job can be dispersed. In the present embodiment, the plurality of the image forming apparatuses 421˜424 have a function of sharing the jobs among them.

In the image forming apparatus 100 (for example, the image forming apparatuses 421˜424) according to the present embodiment, the determination section 304 determines the registration destination of the job in a case of receiving a job registration request. The job transfer controller 305 transfers the data of the job to the registration destination determined by the determination section 304. The job registration controller 308 registers the data of the job transmitted from another apparatus. The job list delivery controller 306 delivers the information on the job list for registration by the job registration controller 308.

Therefore, in the image forming apparatus 100 according to the present embodiment, in a case of receiving the job registration request, it is possible to transfer the data of the job to an appropriate registration destination. In the image forming apparatus 100 according to the present embodiment, it is possible to register the transmitted data of the job, deliver the information on the job list, and notify the information. Thus, in the image forming apparatus 100 according to the present embodiment, the data can be distributed.

In the image forming apparatus 100 according to the present embodiment, the determination section 304 determines the image forming apparatus having a smaller number of registered jobs among a plurality of the image forming apparatuses including the image forming apparatus 100 of its own as the registration destination of the job.

Therefore, in the image forming apparatus 100 according to the present embodiment, it is possible to distribute the data by registering the job in the image forming apparatus having the small number of registered jobs.

In the image forming apparatus 100 according to the present embodiment, the determination section 304 determines the image forming apparatus having a larger free capacity of the storage among a plurality of the image forming apparatuses including the image forming apparatus 100 of its own as the registration destination of the job.

Therefore, in the image forming apparatus 100 according to the present embodiment, it is possible to distribute the data by registering the job in the image forming apparatus having the large free capacity of the storage.

In the image forming apparatus 100 according to the present embodiment, the job registration controller 308 registers the data of the job if the determination section 304 determines that the registration destination of the job is the image forming apparatus 100 of its own.

Therefore, in the image forming apparatus 100 according to the present embodiment, it is possible to distribute the data if it is suitable to register the data of the job in the image forming apparatus 100 itself.

In the image forming apparatus 100 according to the present embodiment, the job list delivery controller 306 transmits the information on the job list to the other image forming apparatuses.

Therefore, in the image forming apparatus 100 according to the present embodiment, the contents of the job lists can be the same in the plurality of the image forming apparatuses.

In the image forming apparatus 100 according to the present embodiment, the job execution controller 307 requests the data of the job from another apparatus. The determination section 304 determines whether to register the job if the data of the job requested by the job execution controller 307 is received from another apparatus. The job registration controller 308 registers the data of the job if the determination section 304 determines that the job is registered. The job list delivery controller 306 delivers the information on the job list for registration by the job registration controller 308.

Therefore, in the image forming apparatus 100 according to the present embodiment, in a case in which the data of the job is requested, if the image forming apparatus 100 itself is suitable, the data of the job can be registered. In the image forming apparatus 100 according to the present embodiment, the information on the job list can be delivered and notified for the job. Thus, in the image forming apparatus 100 according to the present embodiment, the data can be distributed.

In the image forming apparatus 100 according to the present embodiment, the determination section 304 determines to register the job if the number of registered jobs in the image forming apparatus 100 itself is smaller compared with the other apparatuses.

Therefore, in the image forming apparatus 100 according to the present embodiment, it is possible to distribute the data by registering the job in the image forming apparatus 100 itself having the small number of registered jobs.

In the image forming apparatus 100 according to the present embodiment, the determination section 304 determines to register the job if there is a larger free capacity of the storage in the image forming apparatus 100 itself compared with the other apparatuses.

Therefore, in the image forming apparatus 100 according to the present embodiment, it is possible to distribute the data by registering the job to the image forming apparatus 100 itself having the large free capacity of the storage.

In the image forming apparatus 100 according to the present embodiment, the job list delivery controller 306 transmits the information on the job list to the other image forming apparatuses.

Therefore, in the image forming apparatus 100 according to the present embodiment, the contents of the job list can be the same in the plurality of the image forming apparatuses.

A processing method in which the image forming apparatus 100 according to the present embodiment executes the processing on the data of the job has a first step, a second step, a third step, and a fourth step. In the first step, in a case of receiving the job registration request, the registration destination of the job is determined. In the second step, the data of the job is transferred to the determined registration destination. In the third step, the data of the job transferred from another apparatus is registered. In the fourth step, the information on the job list is delivered for registration.

### Second Embodiment

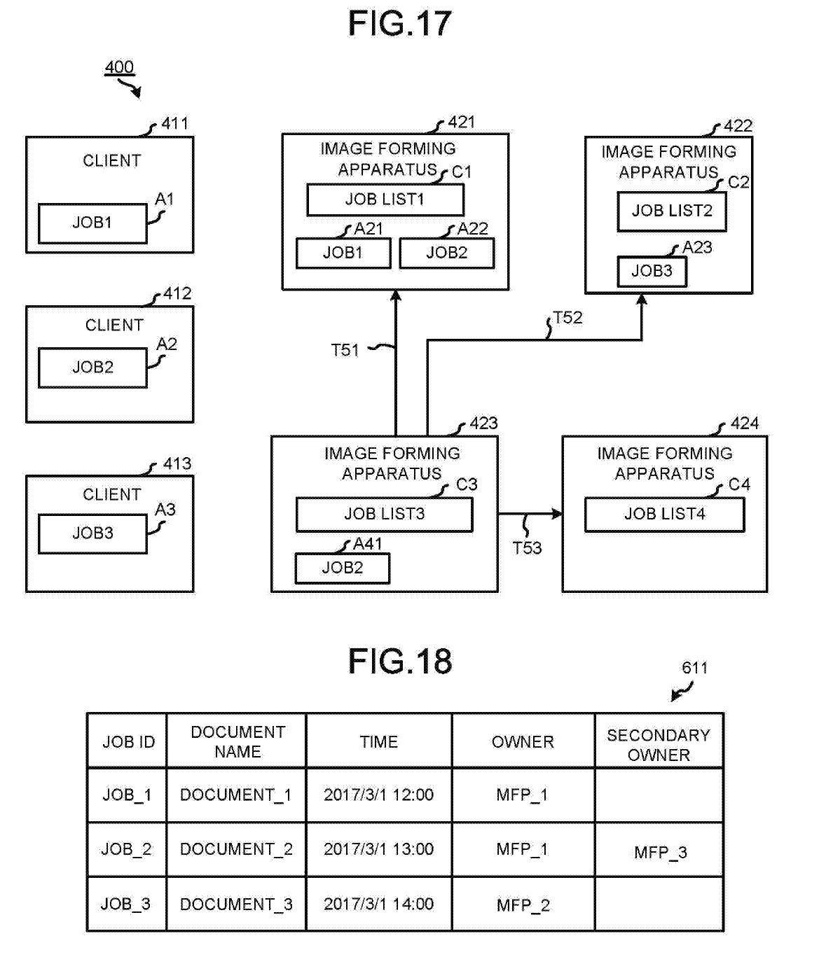

With reference to FIG. 17 to FIG. 19, redundant processing data (improvement of redundancy) at the time of printing a job is described. Due to the redundant processing data, the redundancy of the processing data is improved.

The present embodiment is different from the first embodiment in that a secondary owner is set together with the owner for one job. The secondary owner is managed by job lists C1˜C4. In the job lists C1˜C4 in the present embodiment, information on the secondary owner is added to the job lists B1-B4 in the first embodiment.

First, a state shown in FIG. 12 is assumed. The image forming apparatus 423 requests the data of the job A2 as the print data from the image forming apparatus 421. Then, the image forming apparatus 421 transmits the data of the job A2 as the requested print data to the image forming apparatus 423.

An example of the operation at the time of printing the job is described with reference to FIG. 7.

FIG. 17 is a diagram illustrating an example of the operation at the time of printing the job according to the embodiment. The network 431 is not shown for the ease of view of the figure. In FIG. 17, a communication flow is indicated by an arrow in order to make the communication flow easy to understand.

In the present example, in a case of receiving the data of the job A2 as the print data, the image forming apparatus 423 sets the image forming apparatus 423 as the secondary owner for the job A2. Specifically, the image forming apparatus 423 creates the data of a job A41 corresponding to the data of the job A2 as the print data to store it. By storing the data of the job A41 in the storage section 320, the image forming apparatus 423 registers the job A41 in the image forming apparatus 423 as the secondary owner. As a result, the data of the same job A2 is simultaneously stored in the two image formation apparatuses 421 and 423. In the present example, the image forming apparatus 421 is the owner and the image forming apparatus 423 is the secondary owner for the job A2. The owner represents the first owner holding the data of the job. The secondary owner represents the secondary owner holding the data of the job. In the present example, the data of the job is the print data.

The image forming apparatus 423 rewrites the job list C3 of the image forming apparatus 423 to reflect the information on the job A2 registered in the job list C3 as the secondary owner. The image forming apparatus 423 shares the information on the job lists with the other image forming apparatuses 421, 422 and 424 cooperating therewith. Specifically, the image forming apparatus 423 delivers information on the job list by transmitting it to the other image forming apparatuses 421, 422 and 424. The information on the job list includes at least a change part.

In the present example, the image forming apparatus 423 transmits the information on the job list to the image forming apparatus 421 as a job list delivery processing T51. The image forming apparatus 423 transmits the information on the job list to the image forming apparatus 422 as a job list delivery processing T52. The image forming apparatus 423 transmits the information on the job list to the image forming apparatus 424 as a job list delivery processing T53.

Herein, in the present example, the information on the job list includes at least the information on the secondary owner of the job A2. The other image forming apparatuses 421, 422 and 424 receive the information on the job list. Then, the other image forming apparatuses 421, 422 and 424 rewrite the job lists C1, C2 and C4 thereof. As a result, the other image forming apparatuses 421, 422 and 424 reflect the information on the secondary owner of the job A2 in the job lists C1, C2 and C4.

In the present example, in the image forming apparatus 423, the job execution controller 307 controls the processing of printing the data of the job A2.

With reference to FIG. 18, a job list 611 is described.

FIG. 18 is a diagram illustrating an example of the job list 611 according to the embodiment.

The job list 611 is an example of the job lists C1˜C4.

The job list 611 has contents of the job list 512 shown in FIG. 8. Further, the job list 611 is associated with the secondary owner for each job ID.

Specifically, the “Job_2” is stored as the job ID of the job A2 in the job list 611. The “Document_2” is stored as the document name of the job A2. “2017/3/1 13: 00” is stored as time for the job A2. The “MFP_1” is stored as the owner of the job A2. The “MFP_3” is stored as the secondary owner of the job A2.

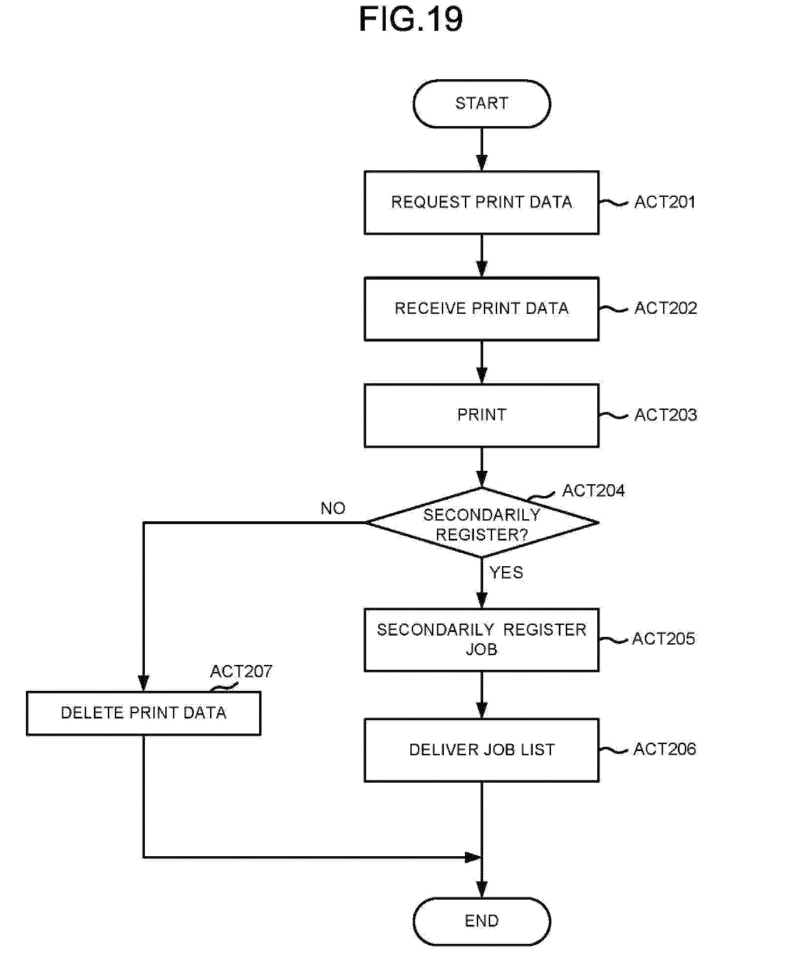

With reference to FIG. 19, the flow of a processing executed by the image forming apparatus 423 issuing the job print request is described.

FIG. 19 is a flowchart illustrating an example of the flow of the processing executed by the image forming apparatus 423 issuing the job print request according to the embodiment.

In the image forming apparatus 423, in a case of printing the print data, the job execution controller 307 requests the print data based on the contents of the job list B3 (ACT 201). In the present example, the job execution controller 307 requests the data of the job A2 as the print data from the image forming apparatus 421.

Next, the image forming apparatus 423 receives the print data transmitted from the image forming apparatus 421 (ACT 202). Then, the job execution controller 307 executes the processing on the received print data (ACT 203).

The determination section 304 determines whether to register the image forming apparatus 423 as the secondary owner of the received print data (ACT 204). As a result, if the determination section 304 determines to register the image forming apparatus 423 as the secondary owner (Yes in ACT 204), the determination section 304 proceeds to the processing in ACT 205. On the other hand, if the determination section 304 determines not to register the image forming apparatus 423 as the secondary owner (No in ACT 204), the determination section 304 proceeds to the processing in ACT 207.

In ACT 205, the job registration controller 308 stores the data of the job A2 in the storage section 320. As a result, the job registration controller 308 registers the job A2 in the image forming apparatus 423 as the secondary owner thereof (ACT 205). In the registration, the job registration controller 308 rewrites the job list B3 of the image forming apparatus 423. Then, the job list delivery controller 306 delivers information on the rewritten job list B3 to the other image forming apparatuses 421, 422 and 424 (ACT 206). After that, the present flow is ended. The information includes at least the information on the newly registered job A2 whose secondary owner is set.

In the ACT 207, the job registration controller 308 deletes the data of the job A2. Thereafter, the present flow is ended.

Herein, the operation in FIG. 19 is described by using the image forming apparatus 423 as an example; however, the other image forming apparatuses 421, 422 and 424 also have the function of executing the same operations.

An arbitrary condition may be used as the condition for determining whether to register the own apparatus as the secondary owner. As an example, if an image forming apparatus other than the own apparatus is already set as the secondary owner, a condition that the own apparatus is not the secondary owner may be used. Under this condition, if the secondary owner is not registered, the own apparatus becomes the secondary owner.

A case may be described in which there is no condition for determining whether to register the own apparatus as the secondary owner. In other words, the condition that the own device definitely becomes the secondary owner may be used. Under this condition, even if the image forming apparatus other than the own apparatus is already set as the secondary owner, the own apparatus is the secondary owner.

In the present embodiment, an image forming apparatus acquiring the print data initially among the image forming apparatuses 421˜424 becomes an owner. Thereafter, an image forming apparatus other than the owner which prints the print data becomes the secondary owner among the image forming apparatuses 421˜424. Thereafter, if failure occurs in the image forming apparatus which is the owner, it is possible to provide the print data from the image forming apparatus which is the secondary owner. In this way, in the multistation system 400, redundancy can be improved by duplicating the same print data in two or more of the image forming apparatuses 421˜424.

Herein, a case in which a failure occurs in the image forming apparatus which is the owner among the image forming apparatuses 421˜424 is described. Herein, it is assumed that the image forming apparatus 421 is registered as the owner of the data of the job A2. The data is print data. The image forming apparatus 423 is registered as the secondary owner for the data of the job A2.

In this state, it is assumed that the failure occurs in the image forming apparatus 421 which is the owner. For example, a case is described in which the image forming apparatus 424 prints the data of the job A2. In this case, in the image forming apparatus 424, based on the job list C4, the job execution controller 307 recognizes that the owner of the job A2 is the image forming apparatus 421. Then, in the image forming apparatus 424, the job execution controller 307 requests the image forming apparatus 421 which is the owner to transmit the print data of the job A2. However, the communication from the image forming apparatus 421 to the image forming apparatus 424 fails. In the image forming apparatus 424, based on the job list C4, the job execution controller 307 recognizes that the secondary owner of the job A2 is the image forming apparatus 423. In the image forming apparatus 424, the job execution controller 307 requests the image forming apparatus 423 which is the secondary owner to transmit the print data of the job A2. In the image forming apparatus 423, the job transfer controller 305 receiving the request transfers the print data of the job A2 to the image forming apparatus 424. In the image forming apparatus 424, the job execution controller 307 performs control to print the received print data of the job A2.

Herein, in the image forming apparatus 424, if the image forming apparatus 424 becomes a new secondary owner of the job A2, the job registration controller 308 holds the data of the job A2. The data is the print data. On the other hand, if the image forming apparatus 424 does not become the new secondary owner of the job A2, the job registration controller 308 discards the job A2 by deleting the data of the job A2.

In the above description, a case is shown in which the secondary owner is determined at the time of printing the print data in the multistation system 400. As another example, in the multistation system 400, it is also possible to determine the secondary owner at the time of registering print data. For example, as shown in FIG. 5 and FIG. 7, if the client 413 issues a registration request for the job A3, the secondary owner may be determined.

Specifically, the image forming apparatus 421 receiving the data of the job A3 from the client 413 may become the owner of the job A3. The image forming apparatus 421 transfers the data of the job A3 to the other image forming apparatus 422 having a smaller number of registered jobs than the image forming apparatus 421. In a case of receiving the data of the job A3, the image forming apparatus 422 is registered as the secondary owner of the job A3. The image forming apparatus 421 delivers the information on the job list to the other image forming apparatuses 422˜424 while the image forming apparatus 421 becomes the owner. The image forming apparatus 422 delivers the information on the job list to the other image forming apparatuses 421, 423 and 424 while the image forming apparatus 422 becomes the secondary owner.

In this manner, in the server-less multistation system 400, the data of the job is duplicated and distributed in the system. As a result, redundancy of the data of the job can be improved.

In the image forming apparatus 100 (for example, the image forming apparatuses 421˜424) according to the present embodiment, if the determination section 304 receives the job registration request, the determination section 304 determines a secondary registration destination of the job. The job transfer controller 305 transfers the data of the job to the secondary registration destination determined by the determination section 304. The job registration controller 308 secondarily registers the data of the job transferred from another apparatus. The job list delivery controller 306 delivers the information on the job list for the secondary registration by the job registration controller 308.

Therefore, in the image forming apparatus 100 according to the present embodiment, in a case of receiving the job registration request, the data of the job can be transferred to an appropriate secondary registration destination. In the image forming apparatus 100 according to the present embodiment, it is possible to secondarily register the transferred data of the job, deliver the information on the job list and notify the information. Thus, in the image forming apparatus 100 according to the present embodiment, the redundancy of the data is possible.

In the image forming apparatus 100 according to the present embodiment, the job registration controller 308 registers the data of the job as the owner in a case of receiving the job registration request. The job list delivery controller 306 delivers the information on the job list for the registration by the job registration controller 308.

Therefore, in the image forming apparatus 100 according to the present embodiment, in a case of receiving the job registration request, it is possible for the image forming apparatus which is the owner to register the data of the job, deliver the information on the job list, and notify the information.

In the image forming apparatus 100 according to the present embodiment, the job execution controller 307 requests the data of the job from another apparatus. If the data of the job requested by the job execution controller 307 is received from another apparatus, the determination section 304 determines whether to secondarily register the job. The job registration controller 308 secondarily registers the data of the job if the determination section 304 determines that the job is secondarily registered. The job list delivery controller 306 delivers the information on the job list for the secondary registration by the job registration controller 308.

Therefore, in the image forming apparatus 100 according to the present embodiment, in a case of requesting the data of the job, if the own apparatus is suitable, the data of the job can be secondarily registered. In the image forming apparatus 100 according to the present embodiment, it is possible to deliver the information on the job list and notify the information for the secondary registration of the data of the job. Thus, in the image forming apparatus 100 according to the present embodiment, the redundancy of the data is possible.

As another example, in the image forming apparatus 100 according to the present embodiment, the job execution controller 307 requests the data of the job from another apparatus. If the data of the job requested by the job execution controller 307 is received from another apparatus, the job registration controller 308 secondarily registers the data of the job. The job list delivery controller 306 delivers the information on the job list for the secondary registration by the job registration controller 308.

Therefore, in the image forming apparatus 100 according to the present embodiment, if the data of the job is requested, the data of the job can be registered secondarily. In the image forming apparatus 100 according to the present embodiment, it is possible to deliver the information on the job list and notify the information for the secondary registration of the data of the job. Thus, in the image forming apparatus 100 according to the present embodiment, the redundancy of the data is possible.

According to at least one embodiment described above, the image forming apparatus 100 has a function of determining the registration destination of a job and registering the data of the job in the determined registration destination. As a result, the data can be distributed in the image forming apparatus 100.

Furthermore, the image forming apparatus 100 has a function of determining the secondary registration destination of the job and secondarily registering the data of the job to the determined secondary registration destination. Thus, in the image forming apparatus 100, the redundancy of the data is possible.

A program for realizing the functions of the apparatus (for example, the image forming apparatus 100) according to the embodiment described above may be recorded in a recording medium. The recording medium is a computer-readable recording medium. The program recorded in the recording medium may be read by a computer system to be executed to execute a processing. The computer system may include an OS (Operating System) or hardware such as peripheral device. The computer-readable recording medium may be various storage devices. The storage device is, for example, a rewritable nonvolatile memory such as a flexible disk, a magneto-optical disk, a ROM (Read Only Memory), a flash memory or the like. The storage device is, for example, a portable medium such as a DVD (Digital Versatile Disc), a hard disk built in the computer system or the like. The computer-readable recording medium is, for example, a non-transitory recording medium.

Furthermore, the above program may be transferred from the computer system for storing the program in a storage device to another computer system. For example, the transfer may be executed via a transfer medium. For example, the transfer may be executed by a transfer wave in the transfer medium.

Herein, the transfer medium that transfers the program refers to a medium having a function of transmitting the information. The transfer medium is, for example, a network (communication network) such as an Internet or a communication line (communication wire) such as a telephone line.

Further, the above program may realize a part of the above-described functions. Furthermore, the above-described program may realize the above-described function by combination with a program already recorded in the computer system. The program may be a so-called difference file (difference program).

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and there equivalents are intended to cover such forms or modifications as would fall within the scope and spirit of the invention.

1. An image forming apparatus, comprising:
a memory that stores computer executable-components; and
a processor that executes the following computer-executable components stored in a memory, wherein the computer-executable components comprise:
a determination section configured to determine one of another image forming apparatus as registration destination of a job if a job registration request is received;
a job transfer controller configured to transfer data of the job to the registration destination one of another image forming apparatuses determined by the determination section;
a job registration controller configured to register data of a job transferred from another image forming apparatus; and
a job list delivery controller configured to deliver information relating to a job list for registration by the job registration controller to another image forming apparatuses.

2. The image forming apparatus according to claim 1, wherein
the determination section determines an available image forming apparatus having a smaller number of registered jobs among a plurality of image forming apparatuses including the image forming apparatus as the registration destination of the job.

3. The image forming apparatus according to claim 1, wherein
the determination section determines an available image forming apparatus having a larger free capacity of a storage among a plurality of image forming apparatuses including the image forming apparatus as the registration destination of the job.

4. The image forming apparatus according to claim 1, wherein
the job registration controller registers the data of the job if the determination section determines the image forming apparatus as the registration destination of the job.

5. The image forming apparatus according to claim 1, wherein
the job list delivery controller transmits information on the job list to an available image forming apparatus from a plurality of image forming apparatuses.

6. An image forming apparatus, comprising:
a memory that stores computer executable-components; and
a processor that executes the following computer-executable components stored in a memory, wherein the computer-executable components comprise:
a job execution controller configured to request data of a job from another image forming apparatus;
a determination section configured to determine whether to register the job in a case of receiving the data of the job requested by the job execution controller from the another image forming apparatus;
a job registration controller configured to register the data of the job in a case in which the determination section determines that the job is registered; and
a job list delivery controller configured to deliver information relating to a job list for registration by the job registration controller.

7. The image forming apparatus according to claim 6, wherein
the determination section determines to register the job if the number of registered jobs in the image forming apparatus is smaller than that in another image forming apparatus.

8. The image forming apparatus according to claim 6, wherein
the determination section determines to register the job if there is a larger free capacity of a storage in the image forming apparatus compared with another image forming apparatus.

9. The image forming apparatus according to claim 6, wherein
the job list delivery controller transmits information on the job list to another image forming apparatuses.

10. The image forming apparatus according to claim 6, wherein
the job registration controller registers the data of the job if the determination section determines the image forming apparatus as a registration destination of the job.

11. A processing method by an image forming apparatus comprising a processor to execute a processing on data of a job, comprising:
determining a registration destination of the job in a case of receiving a job registration request;
transferring the data of the job to the determined registration destination;
registering the data of the job transferred from another image forming apparatus; and
delivering information on a job list for registration.

12. The processing method according to claim 11, further comprising:
determining an available image forming apparatus having a smaller number of registered jobs among a plurality of image forming apparatuses including the image forming apparatus as the registration destination of the job.

13. The processing method according to claim 11, further comprising:
determining an available image forming apparatus having a larger free capacity of a storage among a plurality of image forming apparatuses including the image forming apparatus as the registration destination of the job.

14. The processing method according to claim 11, further comprising:
registering the data of the job if the determination section determines the image forming apparatus as the registration destination of the job.

15. The processing method according to claim 11, further comprising:
transmitting information on the job list to an available image forming apparatus from a plurality of image forming apparatuses.

16. A processing method by an image forming apparatus comprising a processor to execute a processing on data of a job, comprising:
requesting data of a job from another image forming apparatus;
determining whether to register the job in a case of receiving the data of the job requested from another image forming apparatus;
registering the data of the job in a case in which the job is registered; and
delivering information relating to a job list for registration.

17. The processing method according to claim 16, further comprising:
determining to register the job if the number of registered jobs in the image forming apparatus is smaller than that in another image forming apparatus.

18. The processing method according to claim 16, further comprising:
determining to register the job if there is a larger free capacity of a storage in the image forming apparatus compared with another image forming apparatus.

19. The processing method according to claim 16, further comprising:
transmitting information on the job list to another image forming apparatus.

20. The processing method according to claim 16, further comprising:
registering the data of the job if the image forming apparatus is a registration destination of the job.
